(19) United States
(12) Patent Application Publication
(10) Pub. No.: US 2007/0134542 A1
(43) Pub. Date: Jun. 14, 2007

(54) FLOW BOARD FOR FUEL CELL

(76) Inventors: TSANG-MING CHANG, Taipei (TW); Chihi-Jung Kao, Taipei (TW); Chun-Wei Pan, Taipei (TW)

Correspondence Address: G. LINK CO., LTD., 3550 BELL ROAD, MINOOKA, IL, 60447, US

(21) Appl. No.: 11/567,930

(22) Filed: Dec. 7, 2006

(30) Foreign Application Priority Data
Dec. 9, 2005 (TW) 094221451

(51) Int. Cl. H01M 8/02; B32B 15/04

(52) U.S. Cl. 429/38; 428/457

(57) ABSTRACT

A flow board applied to a fuel cell is disclosed. The fuel cell includes at least one membrane electrode assembly. The flow board comprises a plate body having one or more concave portions, each of which is disposed corresponding to the position of a membrane electrode assembly, and one or more current collection sheets made from a conductive material, wherein each current collection sheet covers a corresponding concave portion of the plate body, and the current collection sheets are fixed on the plate body.

### FIELD OF THE INVENTION

The present invention relates to a flow board for a fuel cell, and more particularly, to a flow board capable of collecting current.

### BACKGROUND OF THE INVENTION

A fuel cell is a power generator, which converts chemical energy stored within fuels and oxidants directly into electricity through a reaction at its electrodes. The kinds of fuel cells are diverse and their classifications are varied. According to the properties of electrolytes thereof, fuel cells can be divided into five types including alkaline fuel cells, phosphoric acid fuel cells, proton exchange membrane fuel cells, fuse carbonate fuel cells, and solid oxide fuel cells.

In the configuration of a conventional fuel cell, an anode flow board and a cathode flow board are respectively disposed at the anodes and the cathodes of membrane electrode assemblies, the materials of the flow boards have the characteristics of good conductivity, high intensity, easy processing, light weight, and low cost. Presently, materials for flow boards include graphite, aluminum and stainless steel, and usually utilize graphite. Flow channels fabricated on flow boards provide pathways for fuels so that reactants can reach diffusion layers via flow channels and enter catalytic layers for reactions. Additionally, flow boards are capable of conducting current, so the current from reactions can be further applied. For this reason flow boards are also termed current collection plates.

However, a conventional flow board (e.g. a graphite board) is typically large and heavy, and has poor conductivity. Therefore, an improved flow board able to collect current is needed to overcome the aforesaid shortcomings.

### SUMMARY OF THE INVENTION

It is a primary object of the invention to provide a flow board for a fuel cell in which the fuel cell itself is small and light, and the flow board collects current well.

In accordance with the aforementioned object of the invention, a flow board for a fuel cell is provided. The fuel cell includes at least one membrane electrode assembly. The flow board comprises a plate body having one or more concave portions, each of which is disposed corresponding to the position of a membrane electrode assembly, and one or more current collection sheets made from a conductive material, wherein each current collection sheet covers a corresponding concave portion of the plate body, and the current collection sheets are fixed on the plate body.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1A is a perspective and exploded diagram of a flow board according to a preferred embodiment of the invention;

FIG. 1B is a perspective and associated diagram of FIG. 1A;

FIG. 1C illustrates the cross section of FIG. 1B;

FIG. 2A is a perspective and exploded diagram of a flow board according to another preferred embodiment of the invention;

FIG. 2B is a cross-sectional and associated diagram of FIG. 2A;

FIG. 3A is a perspective and exploded diagram of a flow board according to yet another preferred embodiment of the invention;

FIG. 3B is a perspective and associated diagram of FIG. 3A;

FIG. 4A is a perspective and exploded diagram of a flow board according to yet another preferred embodiment of the invention; and

FIG. 4B is a perspective and associated diagram of FIG. 4A.

### DETAILED DESCRIPTION OF THE INVENTION

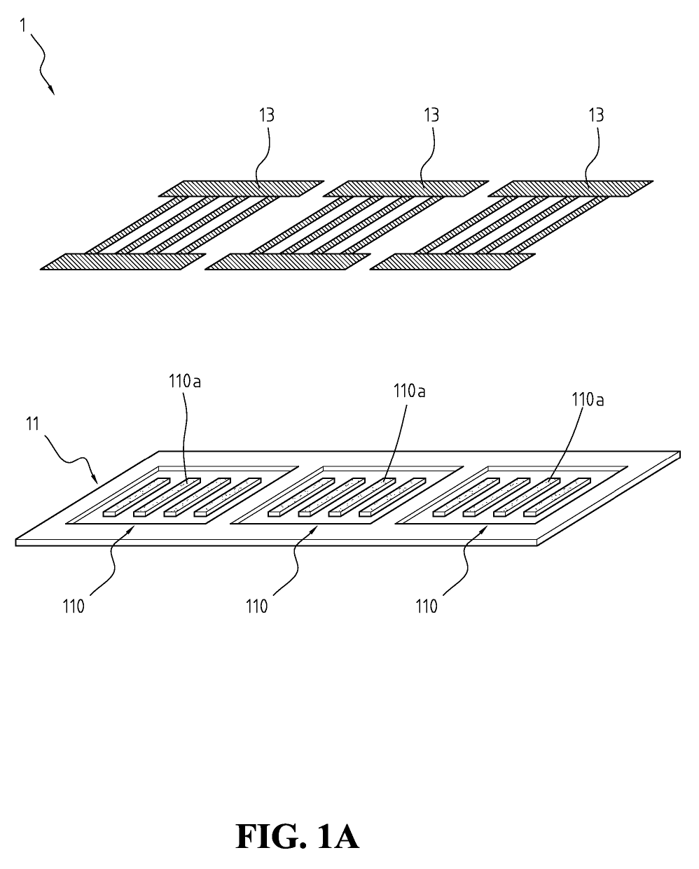

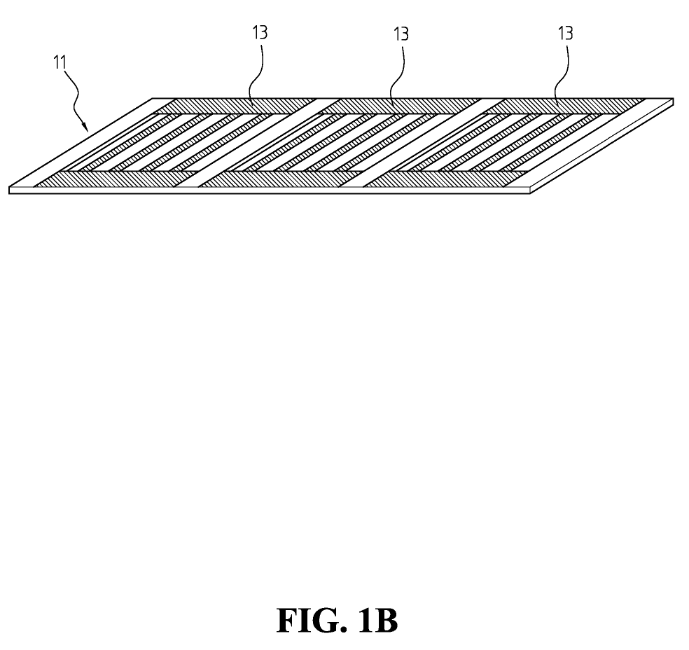

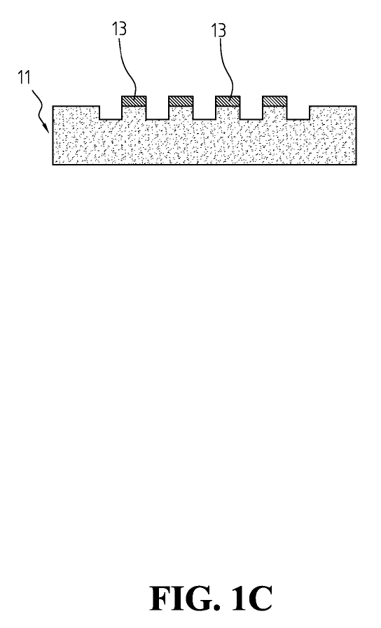

FIG. 1A is a perspective and exploded diagram of a flow board according to a preferred embodiment of the invention. FIG. 1B is a perspective and associated diagram of FIG. 1A. FIG. 1C illustrates the cross section of FIG. 1B. A flow board 1 capable of collecting current may be applied to a fuel cell that has at least one membrane electrode assembly (MEA). The flow board 1 includes a plate body 11 and one or more current collection sheets 13, which are individually described hereinafter.

The plate body 11 may adopt a substrate, such as a chemical-resistant non-conductive engineering plastic substrate, a graphite substrate, a metallic substrate, a plastic carbon substrate, or a composite substrate. The plate body 11 is furnished with at least one concave portion 110. The concave portion 110 is formed on the surface of the plate body 11, and each concave portion 110 is disposed corresponding to the position of a MEA (not shows) of a fuel cell. The flow board 1 further includes one or more support members 110a deployed inside the concave portion 110 in the form of railings.

The current collection sheet 13 which is a thin and flat sheet structure may be made from a conductive material, for example, copper (Cu), stainless steel (SUS316), alloy, or conductive polymer with low resistance. Each current collection sheet 13 covers every concave portion 110 of the plate body 11 and the support members 110a within the concave portion 110. The current collection sheet 13 is fixed on the plate body 11 and sealed onto the surface of the plate body 11 by adhering and/or riveting and/or locking.

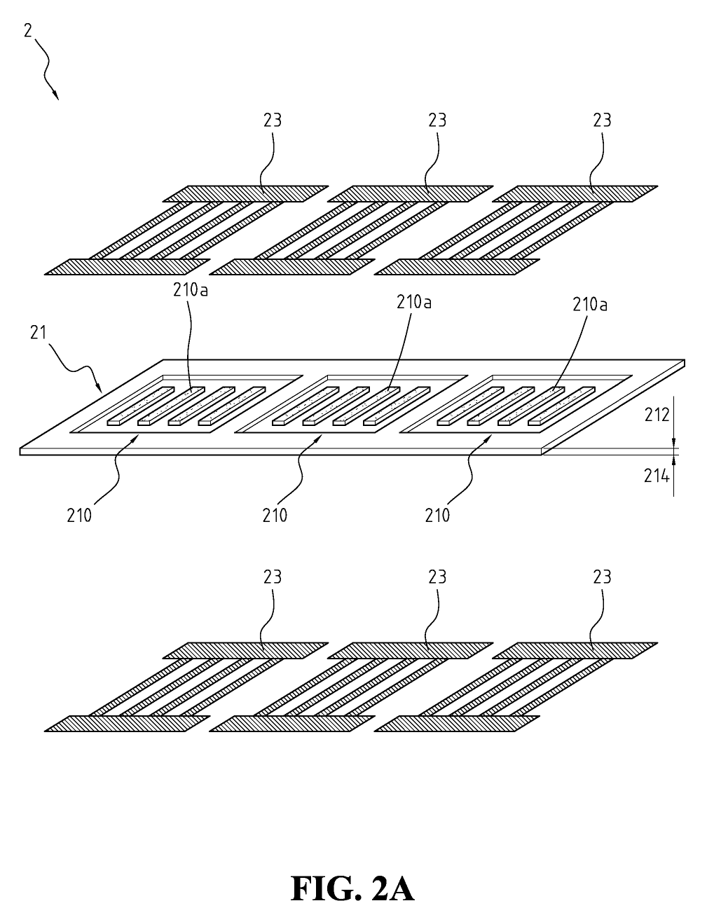

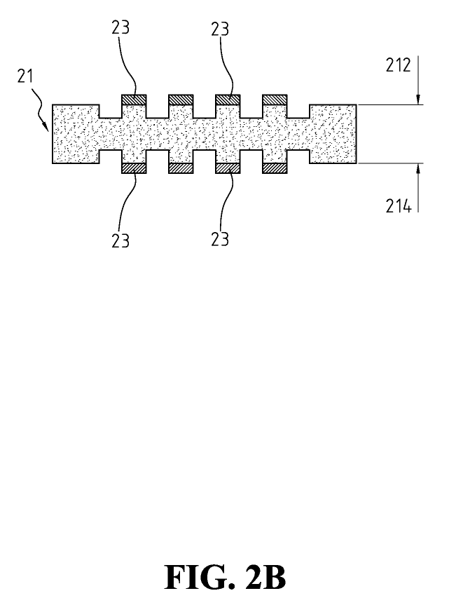

FIG. 2A is a perspective and exploded diagram of a flow board according to another preferred embodiment of the invention. FIG. 2B is a cross-sectional and associated diagram of FIG. 2A. A flow board 2 capable of collecting current is a two-sided flow board, which may be applied to a fuel cell with at least one membrane electrode assembly (MEA). The flow board 2 includes a plate body 21 and one or more current collection sheets 23, which are described separately hereinafter.

The plate body 21 may utilize a substrate, such as a chemical-resistant non-conductive engineering plastic substrate or a composite substrate. The plate body 21 is furnished with one or more concave portions 210. The concave portions 210 are formed on the top surface 212 and bottom surface 214 of the plate body 21. Each concave portion 210 is disposed corresponding to the position of a MEA (not shown) of a fuel cell. The flow board 2 further includes one or more support members 210a deployed inside the concave portion 210 in the form of railings.

The current collection sheet 23 may be made of a conductive material, for example, copper (Cu), stainless steel (SUS316), alloy, or conductive polymer with low resistance. Each current collection sheet 23 covers every concave portion 210 of the plate body 21 and the support members 210a within the concave portion 210. The current collection sheet 23 is fixed on the plate body 21 and sealed onto the top surface 212 and bottom surface 214 of the plate body 21 by adhering and/or riveting and/or locking.

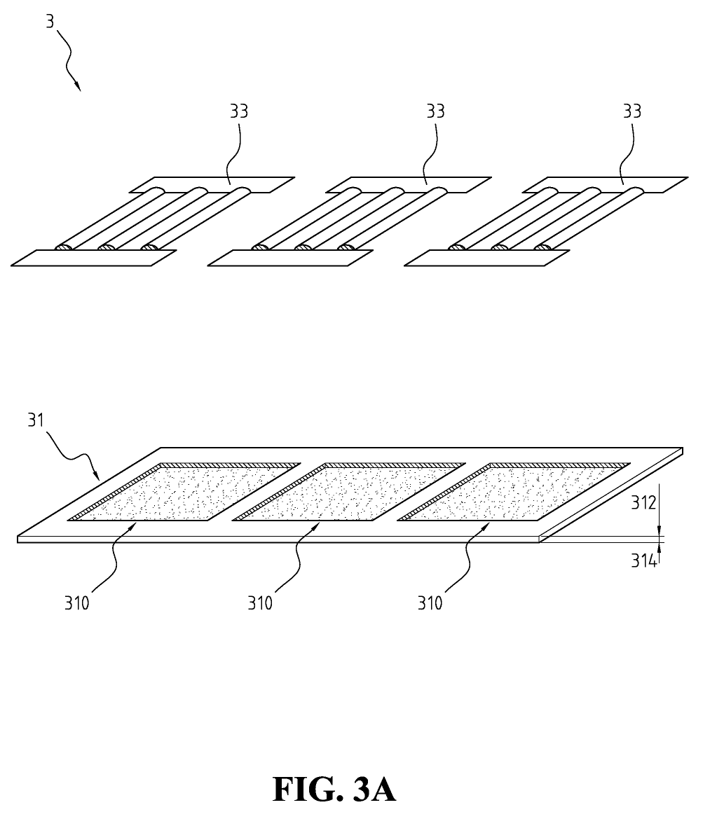

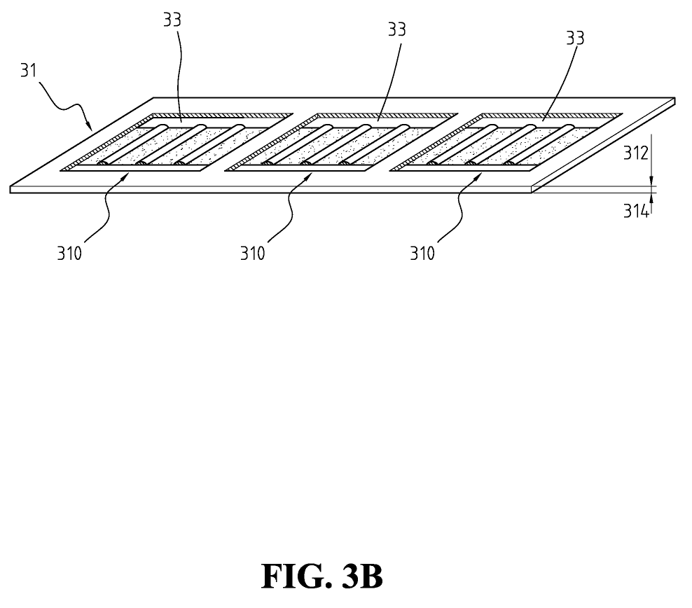

FIG. 3A is a perspective and exploded diagram of a flow board according to still another preferred embodiment of the invention. FIG. 3B is a perspective and associated diagram of FIG. 3A. A flow board 3 capable of collecting current is applied to a fuel cell having at least one membrane electrode assembly (MEA). The flow board 3 includes a plate body 31 and one or more current collection sheets 33, which are separately described hereinafter.

The plate body 31 may utilize a substrate selected from a group consisting of a chemical-resistant non-conductive engineering plastic substrate, a graphite substrate, a metallic substrate, a plastic carbon substrate, and a composite substrate. The plate body 31 is furnished with one or more concave portions 310. The concave portions 310 are formed on a surface of the plate body 31, i.e. the top surface 312 of the plate body 31. Each concave portion 310 is disposed corresponding to the position of a fuel cell MEA.

The current collection sheet 33 may be composed of a conductive material, for example, copper (Cu), stainless steel (SUS316), alloy, or conductive polymer with low resistance. Each current collection sheet 33 may include a wavy structure covering every concave portion 310 of the plate body 31. The current collection sheet 33 is fixed on the plate body 31 and sealed onto the surface of the plate body 31 by adhering and/or riveting and/or locking. Accordingly, the current collection sheet 33 is able to collect current; also, the wavy structure thereof may serve as flow channels. While the concave portion 310 is formed on the top surface 312 of the plate body 31, it may be formed on the bottom surface 314 of the plate body 31. Similarly, the current collection sheet 33 covers every concave portion 310 on the bottom surface 314 of the plate body 31.

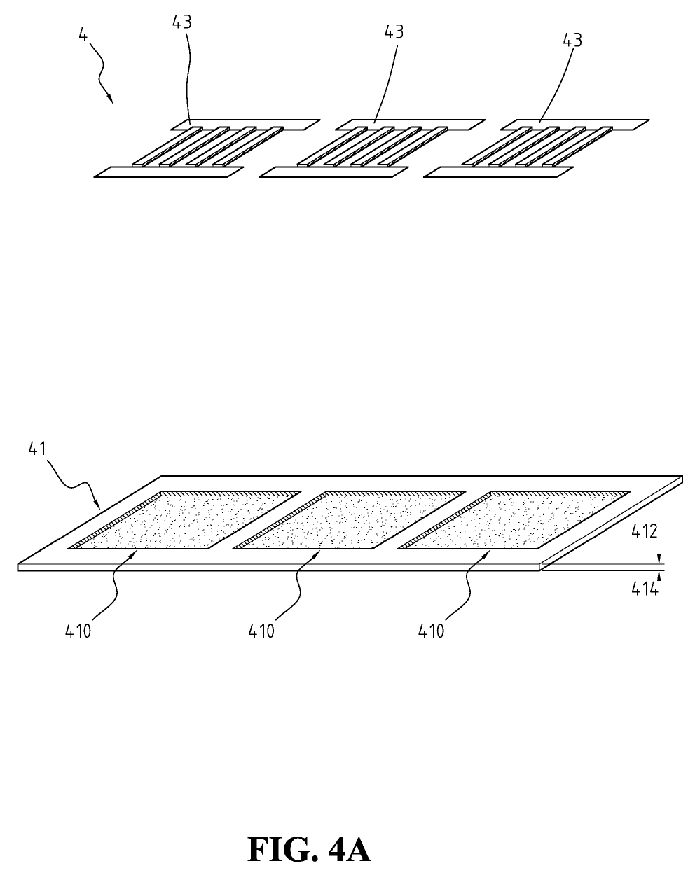

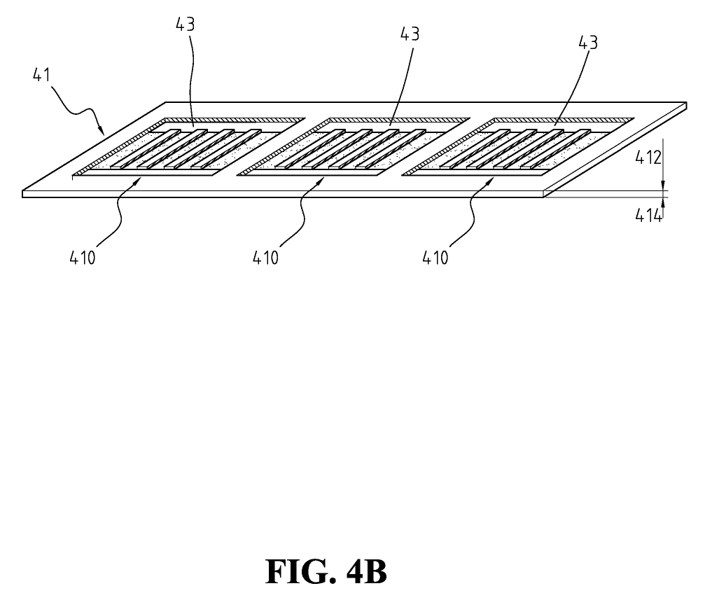

FIG. 4A is a perspective and exploded diagram of a flow board according to yet another preferred embodiment of the invention. FIG. 4B is a perspective and associated diagram of FIG. 4A. A flow board 4 capable of collecting current is applied to a fuel cell comprising at least one membrane electrode assembly (MEA). The flow board 4 includes a plate body 41 and one or more current collection sheets 43, which are respectively described hereinafter.

The plate body 41 may utilize a substrate selected from a chemical-resistant non-conductive engineering plastic substrate, a graphite substrate, a metallic substrate, a plastic carbon substrate, or a composite substrate. The plate body 41 is furnished with one or more concave portions 410. The concave portions 410 are formed on a surface of the plate body 41, i.e. the top surface 412 of the plate body 41. Each concave portion 410 is disposed corresponding to the position of a fuel cell MEA (not shown).

The current collection sheet 43 may be made of a conductive material, such as copper (Cu), stainless steel (SUS316), alloy, or conductive polymer with low resistance. Each current collection sheet 43 may include a railing structure covering every concave portion 410 of the plate body 41. The current collection sheet 43 is fixed on the plate body 41 and sealed onto the surface of the plate body 41 by adhering and/or riveting and/or locking. Accordingly, the current collection sheet 43 is able to collect current; also, the railing structure thereof may be used as flow channels. In addition to the formation of the concave portion 410 on the top surface 412 of the plate body 41, the concave portion 410 may be formed on the bottom surface 414 of the plate body 41. Similarly, the current collection sheet 43 covers every concave portion 410 on the bottom surface 414 of the plate body 41.

The aforementioned flow board may be applied to manifold fuel cells, such as fuel cells employing methanol, or fuel cells with liquid fuels, gaseous fuels or solid fuels. The features and efficacy of the invention are summarized as follows:

1. The current collection sheet may be extremely thinned due to the intrinsic rigidity of the body of a flow board such that the volume and weight of the fuel cell made thereby is greatly reduced. Thus, the compressibility during the fabrication of fuel cells is controllable; and

2. Since the flow board may include a plate body with a chemical-resistant non-conductive engineering plastic substrate and a current collection sheet made of a conductive material, the resultant fuel cell is light and portable, and the flow board collects current effectively. Moreover, the flow board may include a conductive plate body with a graphite substrate or a metallic substrate and a current collection sheet made of a conductive material. So the flow board has better ability to collect current.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A flow board for a fuel cell, the fuel cell includes at least one membrane electrode assembly, the flow board comprising:
a plate body comprising one or more concave portions, each concave portion is disposed corresponding to a position of the membrane electrode assembly, wherein the plate body comprises a substrate selected from a group consisting of a chemical-resistant non-conductive engineering plastic substrate, a graphite substrate, a metallic substrate, a plastic carbon substrate, and a composite substrate;
one or more current collection sheets made from a conductive material, each current collection sheet covers a corresponding concave portion of the plate body, and the current collection sheets are fixed on the plate body, wherein each of the current collection sheets is a railing structure or wavy structure.

2. The flow board of claim 1, wherein the current collection sheet is made of a material selected from a group consisting of copper (Cu), stainless steel (SUS316), alloy, or conductive polymer with low resistance.

3. The flow board of claim 1, wherein the current collection sheet is sealed onto a surface of the plate body by adhering and/or riveting and/or locking.

4. The flow board of claim 1, wherein the concave portions are formed on a top surface and a bottom surface of the plate body.

5. The flow board of claim 1, wherein the concave portions are formed on a top surface of the plate body.

6. The flow board of claim 1, further comprising: one or more support members deployed inside each concave portion.

7. The flow board of claim 6, wherein the support members are deployed in a form of railings.
